(19) United States
(12) Patent Application Publication
(10) Pub. No.: US 2026/0023680 A1
(43) Pub. Date: Jan. 22, 2026

(54) METHOD AND APPARATUS, DEVICE, MEDIUM AND PROGRAM PRODUCT FOR TESTING WEB APPLICATIONS

(71) Applicant: Beijing Zitiao Network Technology Co., Ltd., Beijing (CN)

(72) Inventor: Yunfeng HE, Beijing (CN)

(21) Appl. No.: 19/273,497

(22) Filed: Jul. 18, 2025

Related U.S. Application Data
(63) Continuation of application No. PCT/CN2024/106374, filed on Jul. 19, 2024.

(51) Int. Cl. G06F 11/3668

(52) U.S. Cl. CPC G06F 11/3688

(57) ABSTRACT

Embodiments of the present disclosure relate to a method and apparatus for testing a web application, a device, a medium and a program product. The method comprises obtaining, based on a test case, a target request sent from a web end of the web application to a server end of the web application. The method also comprises determining, based on the target request, whether a traffic file corresponding to the web application is present. The method further comprises in response to presence of the traffic file corresponding to the web application, determining whether the test case is updated. The method also includes in response to the test case not being updated, returning to the web end a target return content corresponding to the target request based on the traffic file, to complete a test for the web application.

### CROSS-REFERENCE TO RELATED APPLICATION(S)

This application claims priority to PCT Application No. PCT/CN2024/106374 filed Jul. 19, 2024, the disclosure of which is incorporated herein by reference in its entirety.

### FIELD

Embodiments of the present disclosure generally relate to the field of Internet, and more specifically, to method and apparatus, device, medium and program product for testing web applications.

### BACKGROUND

Internet has become increasingly important in people's daily life and even an important tool to which people cling. In current society, a mountain of work relies on Internet support, from basic necessities of life, to all kinds of cultural entertainment spread all over the world and to rise of industries. Among Internet technologies, web application is a key direction.

With rapid development of Internet technologies, web application has become an indispensable part of modern life and work. Web application has been extensively applied to provide various services in different scenarios from office to life. While penetrating into every field, web application has greatly enriched the online experience of the users. Meanwhile, increasingly diversified functions of the web application, such as text processing and image creating etc., have satisfied various needs of the users.

### SUMMARY

Embodiments of the present disclosure provide a method and apparatus, a device, a medium and a program product for testing a web application.

In accordance with a first aspect of the present disclosure, there is provided a method for testing a web application. The method comprises obtaining, based on a test case, a target request sent from a web end of the web application to a server end of the web application. The method also includes determining, based on the target request, whether a traffic file corresponding to the web application is present. The method further comprises in response to presence of the traffic file corresponding to the web application, determining whether the test case is updated. The method also contains in response to the test case not being updated, returning a target return content corresponding to the target request to the web end based on the traffic file, to complete a test for the web application.

In accordance with a second aspect of the present disclosure, there is provided an apparatus for testing a web application. The apparatus comprises a target request obtaining module configured to obtain, based on a test case, a target request sent from a web end of the web application to a server end of the web application; a traffic file presence determining module configured to determine, based on the target request, whether a traffic file corresponding to the web application is present; a test case update determining module configured to, in response to presence of the traffic file corresponding to the web application, determine whether the test case is updated; and a target return content returning module configured to, in response to the test case not being updated, return a target return content corresponding to the target request to the web end based on the traffic file, to complete a test for the web application.

In accordance with a third aspect of the present disclosure, there is provided an electronic device, comprising at least one processor; and a storage device for storing at least one program, the at least one program, when executed by the at least one processor, causing the at least one processor to perform the method according to the first aspect of the present disclosure.

In accordance with a fourth aspect of the present disclosure, there is provided a computer-readable storage medium stored thereon with computer programs, the computer programs, when executed by a processor, causing the processor to the method according to the first aspect of the present disclosure.

In accordance with a fifth aspect of the present disclosure, there is provided a computer program product. The computer program product includes computer programs, which computer programs, when executed by a processor, causing the processor to the method according to the first aspect of the present disclosure.

It should be appreciated that the contents described in this Summary are not intended to identify key or essential features of the embodiments of the present disclosure, or limit the scope of the present disclosure. Other features of the present disclosure will be understood more easily through the following description.

### BRIEF DESCRIPTION OF THE DRAWINGS

Through the following detailed description of the example embodiments of the present disclosure with reference to the accompanying drawings, the above and other objectives, features, and advantages of the present disclosure will become more apparent. In the example embodiments of the present disclosure, the same reference sign usually indicates the same component.

FIG. 1 illustrates a schematic diagram of an example environment in which a device and/or method according to embodiments of the present disclosure may be implemented;

FIG. 2 illustrates a schematic diagram of an example flowchart for testing a web application according to embodiments of the present disclosure;

FIG. 3 illustrates a schematic diagram of an example method for testing a web application according to embodiments of the present disclosure;

FIG. 4 illustrates a schematic diagram of example system architecture for testing a web application according to embodiments of the present disclosure;

FIG. 5 illustrates a schematic diagram of an example pseudocode for testing a web application according to embodiments of the present disclosure;

FIG. 6 illustrates a schematic block diagram of an apparatus for testing a web application according to embodiments of the present disclosure;

FIG. 7 illustrates a schematic diagram of example devices suitable for implementing embodiments disclosed herein.

In each drawing, same or corresponding reference sign indicates the same or corresponding component.

### DETAILED DESCRIPTION OF EMBODIMENTS

It is to be understood that data involved in the technical solutions of the present disclosure, including but not limited to data per se, and acquisition or use of the data, should follow requirements of corresponding laws, regulations and rules. In response to receiving an active request from the users, a prompt message is sent to the users to clearly indicate the users that the operation to be executed by request needs to obtain and use their personal information. Therefore, the users may voluntarily select, in accordance with the prompt message, whether to provide their personal information to electronic devices, application programs, servers or storage media among other software or hardware executing operations included in the technical solutions of the present disclosure.

Embodiments of the present disclosure will be described below in more details with reference to the drawings. Although the drawings illustrate some embodiments of the present disclosure, it should be appreciated that the present disclosure can be implemented in various manners and should not be limited to the embodiments explained herein. On the contrary, the embodiments are provided for a more thorough and complete understanding of the present disclosure. It is to be understood that the drawings and the embodiments of the present disclosure are provided merely for the exemplary purpose, rather than restricting the protection scope of the present disclosure.

In the description of the embodiments of the present disclosure, the term “includes” and its variants are to be read as open-ended terms that mean “includes, but is not limited to.” The term “based on” is to be read as “based at least in part on.” The terms “one embodiment” and “this embodiment” are to be read as “at least one example embodiment.” The terms “first”, “second” and so on can refer to same or different objects. The following text also may include other explicit and implicit definitions.

As stated above, there is a plenty of issues to be solved during the test of the web applications. For example, existing schemes of web application test usually depend on communications with a server end interface. In the current continuously integrated test schemes, the tested web applications are often tested using actual online network traffic, which may lead to cost increase.

In the above traditional test schemes, the test for the codes of the web end of the web applications may be influenced by a server end if back-end codes corresponding to the web end are not masked. Meanwhile, network fluctuations and changes of related server interfaces in a test environment also may lead to test failure and further cause termination of the continuously integrated test and reduce the corresponding interception precision. In addition, in a case that the test is performed in a continuously integrated network environment, the problem of interface missing may also exist as the continuously integrated network environment differs from the actual network environment. Moreover, when the web application to be tested and the corresponding server end are at different geographic locations, e.g., in different countries, the resources required by test may be isolated and the permissions needed by the test would also be restricted correspondingly on account of network barriers between countries. In such case, it is impossible to carry out the test smoothly. In a case that an issue emerges during the test, it is impossible to reproduce the emerging issue with the network traffic of the issue site, which may lead to a low test efficiency.

To at least solve the above and other potential problems, embodiments of the present disclosure provide a method for testing a web application. In this method, a computing device may obtain a target request sent from a web end to a server end of the web application in accordance with a test case, wherein the web end may be any form of client that is compatible with the web application. Next, the computing device may determine, based on the target request, whether a traffic file corresponding to the web application is present. When the presence of the traffic file is determined, the computing device is also required to further determine whether the test case is updated or not. After it is determined that the test case is not updated, the computing device may return a target return content corresponding to the target request to the web end using the traffic file, so as to complete the test for the web application. Through this method, the target return content corresponding to the target request is returned at the test device using the traffic file, which fulfills the interception against the network request, reduces dependency on server or network during web application tests, improves stability and accuracy of the tests and enhances user experience.

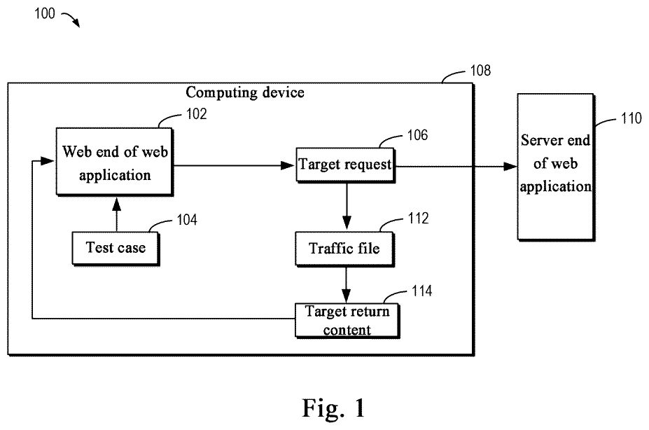

Embodiments of the present disclosure are further described in details below with reference to the drawings, wherein FIG. 1 illustrates an example environment in which the device and/or method according to the embodiments of the present disclosure can be implemented. In the environment 100, the computing device 108 may first obtain a target request 106 sent from a web end 102 of the web application to a server end 110 of the web application in accordance with a test case 104 at the beginning of the test. Afterwards, the computing device 108 determines, based on the target request 106, whether a traffic file 112 corresponding to the web application is present. After determining the presence of the traffic file 112 corresponding to the web application, the computing device 108 is further required to determine whether the test case 104 is updated or not. When it is determined that the test case 104 is not updated, the computing device 108 returns to the web end 102 of the web application a target return content 114 corresponding to the target request 106 with the traffic file 112, to complete the test.

Examples of the computing device 108 include, but not limited to, personal computer, server computer, handheld or laptop device, mobile device (e.g., mobile phone, Personal Digital Assistant (PDA), media player and the like), multi-processor system, consumer electronics, minicomputer, mainframe computer, distributed computing environment including any of the above systems or devices and the like.

As shown in FIG. 1, the computing device 108 tests the web end 102 of the web application with the test case 104, wherein the test case 104 contains a plurality of test items, each of the test items being used for one or more operations executed on the web end 102. Some test items may cause the web end 102 of the web application to send to the server end 110 of the web application a target request for interacting with the server end. In some embodiments, the test case 104 may be updated. In one example, the test case 104 includes 10 test items. In a further example, after the test case 104 is updated, the updated test case includes 15 test items.

When the web end 102 of the web application sends the target request to the server end 110 of the web application, the computing device 108 may be used for intercepting or obtaining the target request 106 sent from the web end 102 of the web application to the server end 110 of the web application.

The computing device 108 also may determine, based on the target request 106, whether the traffic file 112 corresponding to the web end 102 of the web application is present. For example, when the test for the web application begins, the computing device 108 checks the target request 106 after obtaining it to confirm whether the traffic file 112 is present. In one example, the type of the traffic file 112 is a Hypertext Transfer Protocol archive file.

In some embodiments, if the computing device 108 fails to detect the traffic file 112 corresponding to the test case 104, it indicates that the test case 104 is used for the first time. The computing device 108 may create a traffic file for the test case 104, which traffic file is used for storing both the target request sent from the web end 102 of the web application to the server end 110 of the web application and the target return content returned from the server end for the target request on account of the test case 104.

In some embodiments, if the computing device 108 detects the traffic file 112 corresponding to the web end 102 of the web application, it indicates that the test case 104 has been executed before. At this time, it is required to further determine whether the test case 104 is updated. If the test case is not updated, the obtained target request sent from the web end 102 of the web application to the server end of the web application is compared with the reference request stored in the traffic file 112 to determine whether a corresponding reference request is present. In case of the presence of the reference request matching with the target request, the return content for the reference request in the traffic file is provided to the web end 102 of the web application. In such a case, it is no longer required to obtain the return content from the server end 110 of the web application via the network, which prevents the network performance or device problem at the server end from affecting the web end test.

In some embodiments, some interface whitelists may be set during the matching of the target request. The computing device does not intercept the requests in the interface whitelists. In some embodiments, during the matching of the requests corresponding to some interfaces, only part of the fields is matched, rather than all of them. The above example is provided only for describing the present disclosure, rather than restricting it.

In some embodiments, if an update of the test case is detected, it is required to clear information stored in the traffic file. A request related to the server end in the test case is sent to the server end normally. Afterwards, the request sent to the server end and the return content obtained from the server end are re-written into the traffic file. After the test is completed for all test items, the test of the web application is completed.

Through this method, the target request and the target return content are saved in the traffic file in association at the test device, to implement interception and playback of the network request and further support the users to customize the matching rules in the test and enhance the user experience.

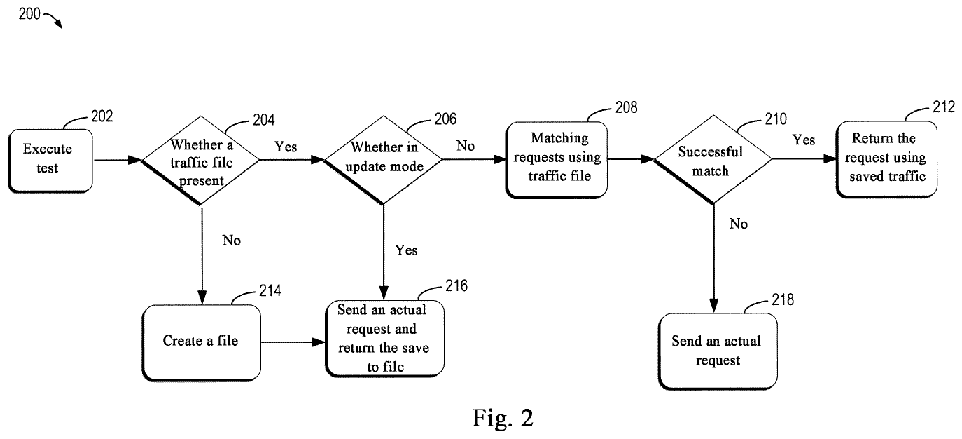

The schematic diagram of the example environment in which the device and/or method according to the embodiments of the present disclosure can be implemented has been depicted above with reference to FIG. 1. A schematic diagram of an example flowchart for testing a web application according to embodiments of the present disclosure is to be described below with reference to FIG. 2. The computing device 108 in FIG. 1 may be used as test device.

As shown in FIG. 2, in the example 200, the computing device begins to execute the test at block 202. It is to be appreciated that the computing device may test all or part of the test items in the test case.

At block 204, the computing device determines whether there is a traffic file corresponding to the web application. If the traffic file is not detected, the computing device creates a file at block 214, e.g. a traffic file for storing all target requests and corresponding return contents.

In addition to creating the traffic file, the computing device also sends the target request to the server end of the web application, to obtain the return content from the server end at block 216. After obtaining the return content from the server end, the computing device may store the target request and the corresponding target return content in the traffic file. In one example, the traffic file is stored at the computing device. In another example, the traffic file is stored on a remote server.

After determining the presence of the traffic file, the computing device further determines whether the test case is in an update mode at block 206, i.e., whether the test case is updated. If the computing device determines that the test case is updated, an actual request is sent to the server end at block 216 and the return is saved to the traffic file. In this process, the computing device sends the target request directly to the server end and stores the target return content associated with the target request in the traffic file simultaneously. Additionally, after determining that the test case is updated, the computing device removes all of the information in the traffic file. Then, the computing device stores the target request and the target return content associated with the target request in the traffic file.

At block 208, the computing device matches the requests using the traffic file. After determining that the test case is not updated, the computing device matches the target request using the traffic file. In one example, the computing device matches the target request with the requests stored in the traffic file.

At block 210, the computing device determines whether there is a successful match. When the traffic file includes a reference request matching with the target request, it indicates a successful match. Next, the computing device further returns the request using the saved traffic at block 212. In this process, the computing device obtains the return content corresponding to the reference request. Afterwards, the computing device returns the return content corresponding to the reference request to the web end as the target return content, to complete the test.

In a case that the traffic file lacks a reference request matching with the target request, an actual request is sent at block 218. At this time, the computing device sends the target request directly to the server end and then receives the target return content corresponding to the target request. Additionally, the computing device may store the target request and the target return content in association in the traffic file.

Through this method, the target request and the target return content are saved in the traffic file in association at the test device, to fulfill interception and playback of the network request and enhance the user experience.

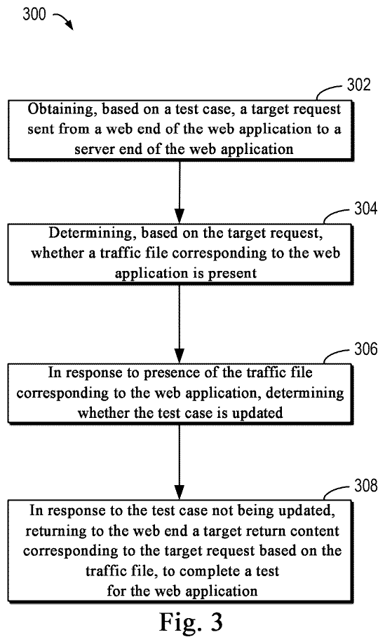

The schematic diagram of an example flowchart for testing a web application according to embodiments of the present disclosure has been depicted above with reference to FIG. 2. Next, a schematic diagram of an example method for testing a web application according to embodiments of the present disclosure is to be described below with reference to FIG. 3. The procedure shown by FIG. 3 can be executed at the computing device 108 illustrated in FIG. 1 or any other suitable computing devices.

As shown in FIG. 3, in the example 300, the computing device obtains the target request sent from the web end of the web application to the server end of the web application based on the test case at block 302. To test the web end of the web application, it is required to design a corresponding test case to detect functions and operations of the web end.

In some embodiments, a plurality of test cases may be configured for the web end of the web application. Each test case may have different roles or functions and may be separately applied to test various functions in the web application. For example, a test case may be used to measure a comment submit function, including test steps of: opening a page, clicking a comment button, adding text in a comment box and clicking a comment submit button etc. An operation of clicking the comment submit button may trigger the web end to send to the server end a target request of submitting the comment. Test operations of opening a page, clicking a comment button and adding text in a comment box are executed at the test device or the web end, without requiring sending a request to the server end.

Subsequently, the computing device determines, based on the target request, whether a traffic file corresponding to the web application is present at block 304. For example, the computing device may check to determine whether the traffic file is present. In some embodiments, the computing device may detect whether a traffic file corresponding to the test case is present in accordance with an identification of the test case. For example, the identification of the test case is also stored correspondingly when a traffic file of the test case is stored. The computing device matches the identification of the test case with the identification of the test case corresponding to the stored traffic file to find the corresponding traffic file.

In some embodiments, when the computing device does not detect a traffic file, a new traffic file is created for the web application test. Meanwhile, the computing device also sends the target request to the server end and receives the return content from the server end. By this time, the computing device will store the request and the corresponding return content in the traffic file.

Next, at block 306, the computing device determines whether the test case is updated in response to presence of the traffic file corresponding to the web application. For example, when the test device detects that the traffic file is currently present, it is required to further determine whether the test case is updated. If the test case is not updated yet, the previous traffic file may still be used. If the test case is updated, it is required to rewrite a traffic file for the test case.

In some embodiments, after the user updates the test case, the computing device may obtain information indicating that the test case is updated. For example, with a flag bit for the test case, it is indicated that the test case is updated. If it is determined that the test case is updated, contents in the traffic file are no longer available. Next, the computing device will delete the contents in the traffic file. Meanwhile, the computing device also sends the target request to the server end and stores the target request and the target return content corresponding to the target request returned from the server end in the traffic file in association.

In the end, at block 308, the computing device returns the target return content corresponding to the target request to the web end based on the traffic file in response to the test case being not updated, so as to complete the test for the web application. When it is determined that the test case is not updated, the computing device may determine the target return content that may be returned to the web end with the traffic file.

In some embodiments, the computing device matches the target request with the reference request in the traffic file. If they match, the computing device determines the return content corresponding to the reference request as the target return content available for the target request. Then, the determined target return content is provided to the web end. If a matching reference request is not found, the computing device may send to the server end a request to obtain the corresponding target return content. Additionally, the request at this moment and the corresponding target return content may also be stored in the traffic file.

In some embodiments, the computing device may preset some whitelist interfaces as a first interface list, and the request for accessing interfaces of the first interface list will not be intercepted. In such a case, while matching the target request with the reference request in the traffic file, the computing device also may determine whether the target request is for the interfaces in the preset first interface list. If the target request is for the interfaces in the first interface list, the target request is sent directly to the server end to obtain the target return content, rather than matching the target request with the reference interface in the traffic file. If the target request is not for the interfaces in the first interface list, the target request matches with the reference request in the traffic file. If matched, the computing device determines the return content corresponding to the reference request as the target return content available for the target request. Then, the determined target return content is provided to the web end. If a matching reference request is not found, the computing device may send to the server end a request to obtain the corresponding target return content. Additionally, the request at this moment and the corresponding target return content may also be stored in the traffic file.

In some embodiments, a second interface list may also be set as required. As to the requests for the interfaces in the second interface list, it is only required to match some key fields or parameters during the matching of the request. For example, an operation request may involve time information during the test process. If the time information is not important for some interfaces, it is configured to not match the time parameters or fields during the request match. In such a case, when matching the target request with the reference request in the traffic file, the computing device also may determine whether the target request is for the interfaces in the second interface list; if the target request is for the interfaces in the second interface list, a match is performed between a partial field of the target request and a partial field of the reference request; if the target request is not for the interfaces in the second interface list, a match is performed between all fields of the target request and all fields of the reference request. In case of a match, the computing device determines the return content corresponding to the reference request as the target return content available for the target request. Then, the determined target return content is provided to the web end. If the matching reference request is not found, the computing device may send to the server end a request to obtain the corresponding target return content. In some embodiments, the test is terminated when all operations in the test case are completed.

Through this method, the target request and the target return content are saved in the traffic file in association at the test device, to fulfill interception and playback of the network request, thereby reducing dependency of the web application test on actual traffic, improving stability and accuracy of the test and enhancing the user experience.

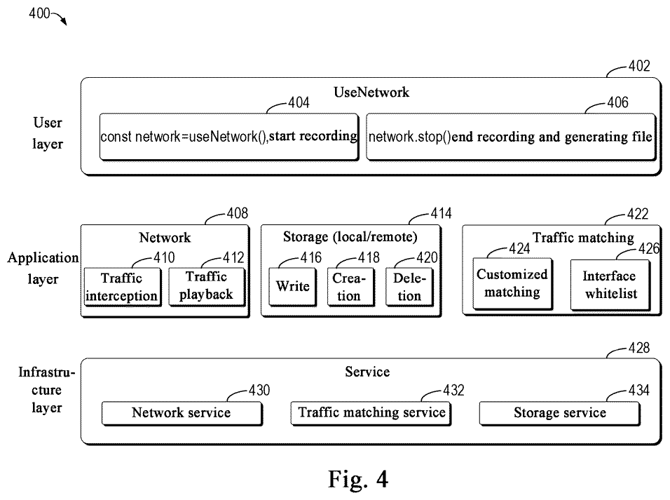

The schematic diagram of an example method for testing a web application in accordance with the embodiments of the present disclosure has been depicted above with reference to FIG. 3. Next, a schematic diagram of example system architecture for testing a web application in accordance with embodiments of the present disclosure is to be described below with reference to FIG. 4.

As shown in FIG. 4, in the example 400, the system architecture is comprised of an infrastructure layer, an application layer and a user layer. It is to be understood that the users may choose other types of system architecture in accordance with their needs as long as they are suitable for implementing the present technical solution. The present application is not restricted in this regard.

At the infrastructure layer, the test device will provide a service module 428 for testing, and the service module includes a network service module 430, a traffic matching service module 432 and a storage service module 434. It is to be appreciated that the users may add other types of services according to their needs and the present disclosure is not restricted in this regard.

The network service provides communication service between the web end and the server end, as well as communication service between the test device and the server end. In one example, the network service may be a remote network service. In another example, the network service may be short range network service, such as local area network service.

The traffic matching service is a matching service between the target request and the reference request in the traffic file. In one example, the matching service is performed based on the identifications in the target request and the reference request.

In some embodiments, the storage service is to store related information in the traffic file. For example, the storage service stores the associated target request and target return content into the traffic file.

At the application layer, there are provided a network module 408, a storage (local/remote) module 414 and a traffic matching module 422, wherein the network module also includes a traffic interception module 410 and a traffic playback module 412; the storage (local/remote) module 414 also includes a write module 416, a creation module 418 and a deletion module 420; and the traffic matching module 422 further includes a customized matching module 424 and an interface whitelist module 426.

While determining presence of a reference request matching with the target request in the traffic file, the traffic interception module intercepts the target request at the test device and then returns the return content corresponding to the reference request to the web end as the target return content, to complete the test.

In a case that the test fails or terminates for some reasons, the traffic playback module executes the traffic playback function to reproduce the specific situations of the traffic during the test procedure, thereby facilitating the users to analyze the reasons for failure or termination in the course of test. Subsequent to the creation of the traffic file, the write module writes the target request and the target return content corresponding thereto into the traffic file in association.

When the test device determines that the test case is updated, the deletion module removes the information that has already been written into the traffic file, to re-write the target request and the target return content corresponding to a new test case.

The customized matching module allows the users to customize matching rules for the traffic file in view of their needs. For instance, the users may define to not match the platform field for one request and not to match the time field for another request. Additionally, the traffic file also has a built-in default matching rule, such that an access request for accessing local services in the test case may directly perform the requested access without matching.

The interface whitelist module enables the users to list part of the interfaces into the whitelist in accordance with their needs. For example, an access request for the interfaces in the whitelist will not be intercepted at the test device. Instead, the access request is directly sent to the server end for direct communication.

The user layer includes a useNetwork module 402. In view of the functional module, the users may record the entire test procedure for traffic playback, so as to analyze and determine all sorts of problems appearing in the test procedure. At block 404, “const network-useNetwork( ) start recording” indicates recording at the beginning of the test procedure. At block 406, “network.stop( ) end recording and generating file” indicates that the recording of the test procedure is stopped and a corresponding file is generated for the recorded test procedure and saved at the completion of the test.

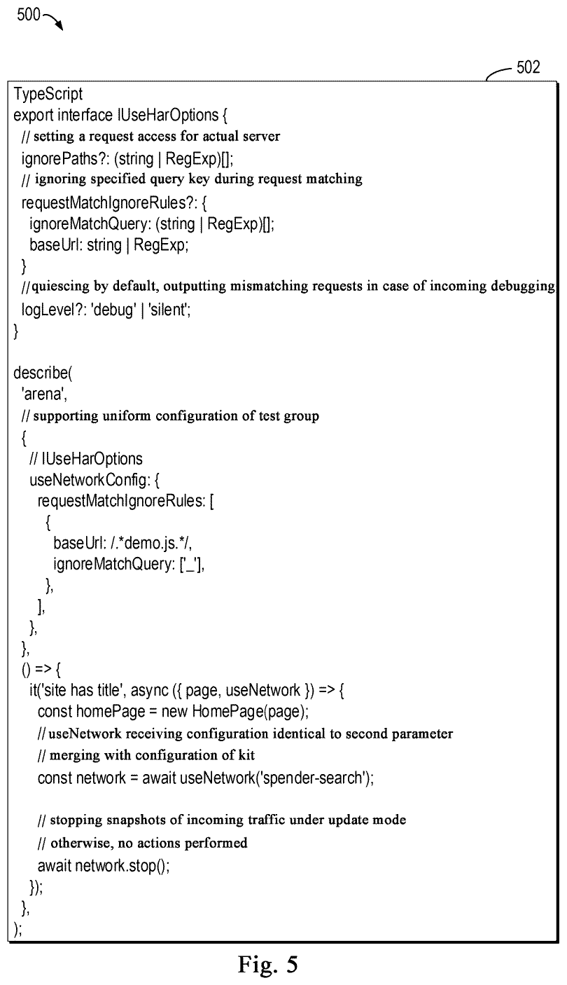

The schematic diagram of example system architecture for testing a web application in accordance with the embodiments of the present disclosure has been depicted above with reference to FIG. 4. Next, a schematic diagram of example pseudocodes for testing a web application in accordance with embodiments of the present disclosure is to be described below with reference to FIG. 5.

In the example 500 shown by FIG. 5, block 502 is an example of the pseudocode. For example, the annotation of “//setting a request access for actual server” indicates that the request may be sent to the server end, such that the target request access may be sent to the server end via the test device.

For another example, the annotation of “//ignoring specified query key during request matching” indicates that preconfigured specific information may be ignored during the matching. For instance, some field information of the request may be ignored during matching. In one example, platform field in the request is ignored during matching. In a further example, time field in the request is ignored during matching.

The annotation of “//quiescing by default, outputting mismatching requests in case of incoming debugging” indicates that the request may be outputted directly if the debugging passes under the default matching rules. For example, in a case that the test device receives an access request for accessing local services, the access request is directly performed.

In the pseudocodes used for execution of the test, the code “const network=await useNetwork (‘spender-search’)” represents calling a useNetwork module to search for a file ‘spender-search’. If the file is not present, it is created and then the calling is performed. For instance, upon detecting the current absence of the traffic file, the computing device executes a job of creating a file to create a traffic file.

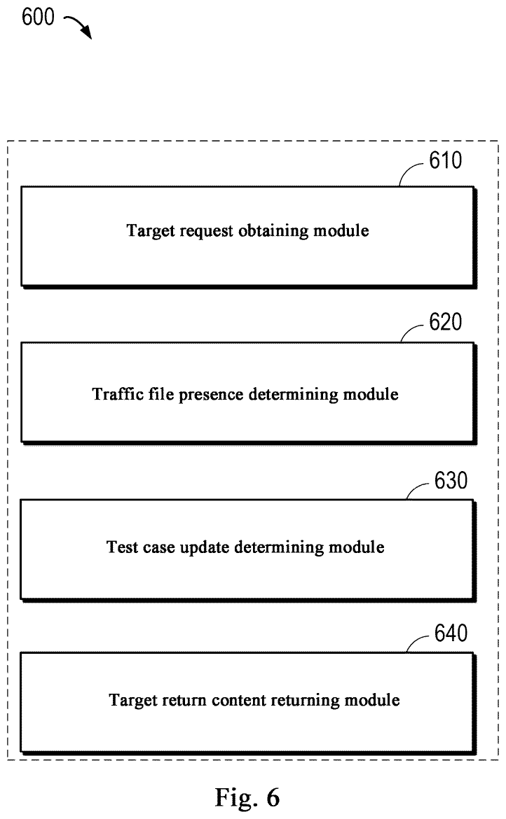

The schematic diagram of example pseudocodes for testing a web application in accordance with embodiments of the present disclosure has been depicted above with reference to FIG. 5. Next, a schematic block diagram of an apparatus for testing a web application in accordance with embodiments of the present disclosure is to be described below with reference to FIG. 6.

As shown in FIG. 6, the apparatus 600 includes a target request obtaining module 610 configured to obtain, based on a test case, a target request sent from a web end of the web application to a server end of the web application; a traffic file presence determining module 620 configured to determine, based on the target request, whether a traffic file corresponding to the web application is present; a test case update determining module 630 configured to, in response to presence of the traffic file corresponding to the web application, determine whether the test case is updated; and a target return content returning module 640 configured to, in response to the test case not being updated, return a target return content corresponding to the target request to the web end based on the traffic file, to complete a test for the web application.

In some embodiments, the target return content returning module 640 includes: a matching module configured to match the target request with a reference request in the traffic file; a return content determining module configured to, in response to presence of the reference request matching with the target request in the traffic file, determine a return content corresponding to the reference request; and a returning module configured to provide the return content to the web end as the target return content.

In some embodiments, the target return content returning module 640 also includes: a target request sending module configured to, in response to absence of the reference request matching with the target request in the traffic file, send the target request to the server end; a target return content receiving module configured to receive the target return content corresponding to the target request; and a storage module configured to store the target return content and the target request in association in the traffic file.

In some embodiments, the matching module includes: a first request determining module configured to determine whether the target request is for an interface in a preconfigured first interface list, wherein interface in the first interface list is an interface that is allowed to be accessed; and a first request matching module configured to, in response to the target request not being for interface in the first interface list, match the target request with a reference request in the traffic file.

In some embodiments, the apparatus 600 further comprises: a first request sending module configured to, in response to the target request being for interfaces in the first interface list, send the target request to the server end; and a first content receiving module configured to receive the target return content corresponding to the target request.

In some embodiments, the matching module includes: a second request determining module configured to determine whether the target request is for interfaces in a second interface list; and a second request matching module configured to, in response to the target request being for interfaces in the second interface list, match part of fields of the target request with part of fields of the reference request.

In some embodiments, the matching module also includes: a second request matching module configured to, in response to the target request not being for interfaces in the second interface list, match all fields of the target request with all fields of the reference request. In some embodiments, the apparatus 600 further comprises: a traffic file creating module configured to, in response to absence of the traffic file corresponding to the web application, create the traffic file; a target return content obtaining module configured to obtain the target return content corresponding to the target request by sending the target request to the server end; and a storage module configured to store the target return content and the target request in association in the traffic file.

In some embodiments, the apparatus 600 also comprises: a removing module configured to, in response to the test case being updated, remove information in the traffic file; a target request sending module configured to send the target request to the server end; a target return content receiving module configured to receive the target return content corresponding to the target request; and a storage module configured to store the target return content and the target request in association in the traffic file.

In some embodiments, the traffic file is a hypertext transfer protocol archive file.

In some embodiments, the apparatus 600 also includes: an access request executing module configured to, in response to obtaining an access request for accessing a local service related to the web end, execute the access request.

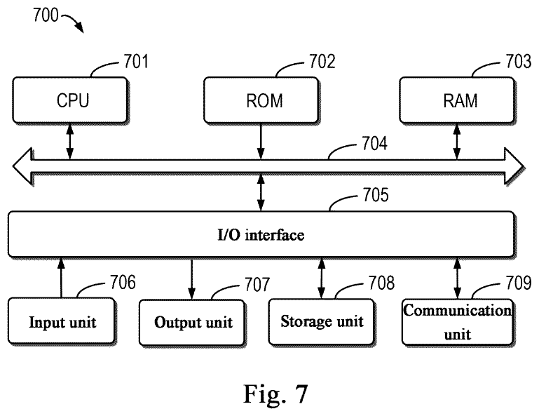

FIG. 7 illustrates a schematic block diagram of an example device 700 for implementing embodiments of the present disclosure. The computing device 108 in FIG. 1 may be implemented by the device. As shown in FIG. 7, the device 700 comprises a central process unit (CPU) 701, which can execute various suitable actions and processing based on the computer program instructions stored in the read-only memory (ROM) 702 or computer program instructions loaded in the random-access memory (RAM) 703. The RAM 703 can also store all kinds of programs and data required by the operation of the device 700. CPU 701, ROM 702 and RAM 703 are connected to each other via a bus 704. The input/output (I/O) interface 705 is also connected to the bus 704.

A plurality of components in the device 700 is connected to the I/O interface 705, including: an input unit 706, such as keyboard, mouse and the like; an output unit 707, e.g., various kinds of display and loudspeakers etc.; a storage unit 708, such as disk and optical disk etc.; and a communication unit 709, such as network card, modem, wireless transceiver and the like. The communication unit 709 allows the device 700 to exchange information/data with other devices via the computer network, such as Internet, and/or various telecommunication networks.

The above described procedure and processing, such as method 300, can be executed by the processing unit 701. For example, in some embodiments, the method 300 can be implemented as a computer software program tangibly included in the machine-readable medium, e.g., storage unit 708. In some embodiments, the computer program can be partially or fully loaded and/or mounted to the apparatus 700 via ROM 702 and/or communication unit 709. When the computer program is loaded to RAM 703 and executed by the CPU 701, one or more actions of the above describe method 400 can be implemented.

The present disclosure can be method, apparatus, system and/or computer program product. The computer program product can include a computer-readable storage medium, on which the computer-readable program instructions for executing various aspects of the present disclosure are loaded.

The computer-readable storage medium can be a tangible apparatus that maintains and stores instructions utilized by the instruction executing apparatuses. The computer-readable storage medium can be, but not limited to, such as electrical storage device, magnetic storage device, optical storage device, electromagnetic storage device, semiconductor storage device or any appropriate combinations of the above. More concrete examples of the computer-readable storage medium (non-exhaustive list) include: portable computer disk, hard disk, random-access memory (RAM), read-only memory (ROM), erasable programmable read-only memory (EPROM or flash), static random-access memory (SRAM), portable compact disk read-only memory (CD-ROM), digital versatile disk (DVD), memory stick, floppy disk, mechanical coding devices, punched card stored with instructions thereon, or a projection in a slot, and any appropriate combinations of the above. The computer-readable storage medium utilized here is not interpreted as transient signals per se, such as radio waves or freely propagated electromagnetic waves, electromagnetic waves propagated via waveguide or other transmission media (such as optical pulses via fiber-optic cables), or electric signals propagated via electric wires.

The described computer-readable program instruction can be downloaded from the computer-readable storage medium to each computing/processing device, or to an external computer or external storage via Internet, local area network, wide area network and/or wireless network. The network can comprise copper-transmitted cable, optical fiber transmission, wireless transmission, router, firewall, switch, network gate computer and/or edge server. The network adapter card or network interface in each computing/processing device receives computer-readable program instructions from the network and forwards the computer-readable program instructions for storage in the computer-readable storage medium of each computing/processing device.

The computer program instructions for executing operations of the present disclosure can be assembly instructions, instructions of instruction set architecture (ISA), machine instructions, machine-related instructions, microcodes, firmware instructions, state setting data, or source codes or target codes written in any combinations of one or more programming languages, wherein the programming languages comprise object-oriented programming languages, e.g., Smalltalk, C++ and so on, and traditional procedural programming languages, such as “C” language or similar programming languages. The computer-readable program instructions can be implemented fully on the user computer, partially on the user computer, as an independent software package, partially on the user computer and partially on the remote computer, or completely on the remote computer or server. In the case where remote computer is involved, the remote computer can be connected to the user computer via any type of networks, including local area network (LAN) and wide area network (WAN), or to the external computer (e.g., connected via Internet using the Internet service provider). In some embodiments, state information of the computer-readable program instructions is used to customize an electronic circuit, e.g., programmable logic circuit, field programmable gate array (FPGA) or programmable logic array (PLA). The electronic circuit can execute computer-readable program instructions to implement various aspects of the present disclosure.

Various aspects of the present disclosure are described here with reference to traffic chart and/or block diagram of method, apparatus (system) and computer program products according to embodiments of the present disclosure. It should be understood that each block of the traffic chart and/or block diagram and the combination of various blocks in the traffic chart and/or block diagram can be implemented by computer-readable program instructions.

The computer-readable program instructions can be provided to the processing unit of general-purpose computer, dedicated computer or other programmable data processing apparatuses to manufacture a machine, such that the instructions that, when executed by the processing unit of the computer or other programmable data processing apparatuses, generate an apparatus for implementing functions/actions stipulated in one or more blocks in the traffic chart and/or block diagram. The computer-readable program instructions can also be stored in the computer-readable storage medium and cause the computer, programmable data processing apparatus and/or other devices to work in a particular manner, such that the computer-readable medium stored with instructions comprises an article of manufacture, including instructions for implementing various aspects of the functions/actions stipulated in one or more blocks of the traffic chart and/or block diagram.

The computer-readable program instructions can also be loaded into computer, other programmable data processing apparatuses or other devices, so as to execute a series of operation steps on the computer, other programmable data processing apparatuses or other devices to generate a computer-implemented procedure. Therefore, the instructions executed on the computer, other programmable data processing apparatuses or other devices implement functions/actions stipulated in one or more blocks of the traffic chart and/or block diagram.

The traffic chart and block diagram in the drawings illustrate system architecture, functions and operations that may be implemented by system, method and computer program product according to multiple implementations of the present disclosure. In this regard, each block in the traffic chart or block diagram can represent a module, a part of program segment or code, wherein the module and the part of program segment or code include one or more executable instructions for performing stipulated logic functions. In some alternative implementations, it should be noted that the functions indicated in the block can also take place in an order different from the one indicated in the drawings. For example, two successive blocks can be in fact executed in parallel or sometimes in a reverse order dependent on the involved functions. It should also be noted that each block in the block diagram and/or traffic chart and combinations of the blocks in the block diagram and/or traffic chart can be implemented by a hardware-based system exclusive for executing stipulated functions or actions, or by a combination of dedicated hardware and computer instructions.

Various embodiments of the present disclosure have been described above and the above description is only exemplary rather than exhaustive and is not limited to the embodiments of the present disclosure. Many modifications and alterations, without deviating from the scope and spirit of the explained various embodiments, are obvious for those skilled in the art. The selection of terms in the text aims to best explain principles and actual applications of each embodiment and technical improvements made in the market by each embodiment, or enable those ordinary skilled in the art to understand embodiments of the present disclosure.

I/We claim:

1. A method for testing a web application, comprising:
obtaining, based on a test case, a target request sent from a web end of the web application to a server end of the web application;
determining, based on the target request, whether a traffic file corresponding to the web application is present;
in response to presence of the traffic file corresponding to the web application, determining whether the test case is updated; and
in response to the test case not being updated, returning a target return content corresponding to the target request to the web end based on the traffic file, to complete a test for the web application.

2. The method according to claim 1, wherein returning the target return content corresponding to the target request to the web end based on the traffic file comprises:
matching the target request with a reference request in the traffic file;
in response to presence of the reference request matching with the target request in the traffic file, determining a return content corresponding to the reference request; and
providing the return content to the web end as the target return content.

3. The method according to claim 2, wherein returning the target return content corresponding to the target request to the web end based on the traffic file further comprises:
in response to absence of the reference request matching with the target request in the traffic file, sending the target request to the server end;
receiving the target return content corresponding to the target request; and
storing the target return content and the target request in association in the traffic file.

4. The method according to claim 3, wherein matching the target request with a reference request in the traffic file comprises:
determining whether the target request is for an interface in a preconfigured first interface list, wherein interface in the first interface list is an interface that is allowed to be accessed; and
in response to the target request not being for the interface in the first interface list, matching the target request with a reference request in the traffic file.

5. The method according to claim 4, further comprising:
in response to the target request being for the interface in the first interface list, sending the target request to the server end; and
receiving the target return content corresponding to the target request.

6. The method according to claim 3, wherein matching the target request with a reference request in the traffic file comprises:
determining whether the target request is for an interface in a second interface list; and
in response to the target request being for the interface in the second interface list, matching part of fields of the target request with part of fields of the reference request.

7. The method according to claim 6, wherein matching the target request with a reference request in the traffic file further comprises:
in response to the target request not being for the interface in the second interface list, matching all fields of the target request with all fields of the reference request.

8. The method according to claim 1, further comprising:
in response to absence of the traffic file corresponding to the web application, creating the traffic file;
obtaining the target return content corresponding to the target request by sending the target request to the server end; and
storing the target return content and the target request in association in the traffic file.

9. The method according to claim 1, further comprising:
in response to the test case being updated, removing information in the traffic file;
sending the target request to the server end;
receiving the target return content corresponding to the target request; and
storing the target return content and the target request in association in the traffic file.

10. The method according to claim 1, further comprising:
the traffic file is a hypertext transfer protocol archive file.

11. The method according to claim 1, further comprising:
in response to obtaining an access request for accessing a local service related to the web end, executing the access request.

12. An electronic device, comprising:
at least one processor; and
a storage device for storing instructions, which executed by the at least one processor, causing the at least one processor to:
obtain, based on a test case, a target request sent from a web end of the web application to a server end of the web application;
determine, based on the target request, whether a traffic file corresponding to the web application is present;
in response to presence of the traffic file corresponding to the web application, determine whether the test case is updated; and
in response to the test case not being updated, return a target return content corresponding to the target request to the web end based on the traffic file, to complete a test for the web application.

13. The device according to claim 12, wherein the instructions causing the processor to return the target return content corresponding to the target request to the web end based on the traffic file comprise instructions causing the processor to:
match the target request with a reference request in the traffic file;
in response to presence of the reference request matching with the target request in the traffic file, determine a return content corresponding to the reference request; and
provide the return content to the web end as the target return content.

14. The device according to claim 13, wherein the instructions causing the processor to return the target return content corresponding to the target request to the web end based on the traffic file further comprise instructions causing the processor to:
in response to absence of the reference request matching with the target request in the traffic file, send the target request to the server end;
receive the target return content corresponding to the target request; and
store the target return content and the target request in association in the traffic file.

15. The device according to claim 14, wherein instructions causing the processor to match the target request with a reference request in the traffic file comprise instructions causing the processor to:
determine whether the target request is for an interface in a preconfigured first interface list, wherein interface in the first interface list is an interface that is allowed to be accessed; and
in response to the target request not being for the interface in the first interface list, match the target request with a reference request in the traffic file.

16. The device according to claim 15, the processor is further caused to:
in response to the target request being for the interface in the first interface list, send the target request to the server end; and
receive the target return content corresponding to the target request.

17. The device according to claim 14, wherein instructions causing the processor to match the target request with a reference request in the traffic file comprise instructions causing the processor to:
determine whether the target request is for an interface in a second interface list; and
in response to the target request being for the interface in the second interface list, match part of fields of the target request with part of fields of the reference request.

18. The device according to claim 17, wherein instructions causing the processor to match the target request with a reference request in the traffic file further comprise instructions causing the processor to:
in response to the target request not being for the interface in the second interface list, match all fields of the target request with all fields of the reference request.

19. The device according to claim 12, the processor is further caused to:
in response to absence of the traffic file corresponding to the web application, create the traffic file;
obtain the target return content corresponding to the target request by sending the target request to the server end; and
store the target return content and the target request in association in the traffic file.

20. A non-transitory computer-readable storage medium stored thereon with computer programs, the computer programs, when executed by a processor, causing the processor to:
obtain, based on a test case, a target request sent from a web end of the web application to a server end of the web application;
determine, based on the target request, whether a traffic file corresponding to the web application is present;
in response to presence of the traffic file corresponding to the web application, determine whether the test case is updated; and
in response to the test case not being updated, return a target return content corresponding to the target request to the web end based on the traffic file, to complete a test for the web application.
